(19) United States
(12) Patent Application Publication
(10) Pub. No.: US 2002/0055907 A1
(43) Pub. Date: May 9, 2002

(54) Electronic payment system and method

(76) Inventors: Orazio Pater, Barrington, IL (US); Andrew Boemi, Northfield, IL (US)

Correspondence Address: Leslie B. Wilson, CARDINAL LAW GROUP, Suite 2000, 1603 Orrington Ave., Evanston, IL, 60201, US

(21) Appl. No.: 10/007,838

(22) Filed: Nov. 8, 2001

Related U.S. Application Data
(60) Provisional application No. 60/246,885, filed on Nov. 8, 2000.

(51) Int. Cl. G06F 17/60

(52) U.S. Cl. 705/39

(57) ABSTRACT

An electronic payment system and method allowing payment by a single action over any electronic finds transfer network and using any pre-determined local or international electronic funds transfer and settlement network. The customer establishes funds transfer static data containing an identification number corresponding to a customer ID, and funds transfer information containing bank account or credit card information; completes a customer transaction to the point of payment; provides the customer ID at a transaction point; and, in response to a single action, transmits payment input data containing the customer ID, payment amount, and transaction date to a finds transfer data and processing host. The funds transfer data and processing host generates finds transfer data by adding finds transfer static data and finds transfer status data to the payment input data; monitors the status data to decide if payment is due; and generates a finds transfer instruction when the status data indicate the payment is due.

### CROSS REFERENCE TO RELATED APPLICATION

This application claims the benefit of U.S. Provisional Application No. 60/246,885, filed Nov. 8, 2000, entitled Electronic Payment System.

### TECHNICAL FIELD

The present invention relates to electronic payment and more particularly to payment over electronic funds transfer networks.

### BACKGROUND OF THE INVENTION

The Internet and the World Wide Web offer opportunities for transacting commerce and transferring funds on an unprecedented scale. Merchants are able to offer their goods to customers worldwide for minimal investment. Customers are able to access goods and services they never thought possible. Customers are able to pay bills without ever touching pen to paper. Still, the potential of Internet commerce is limited by complexity, payment methods and security concerns.

For online consumer sales, the merchant typically provides an online catalog, from which the customer selects what they want to purchase and places the goods in an electronic “shopping cart.” After the customer has selected all the desired goods, they check out by entering personal information, including credit card numbers, and authorizing the transaction. Many transactions are never completed because the customer becomes confused by the complexity of the check out process or becomes concerned with transmitting their credit card number over the Internet. Further business is lost because payment is limited to credit cards: the customer may not have a credit card or their credit card limit may not be sufficient to cover the transaction. From the merchant's standpoint, credit card payment lacks the immediacy and non-repudiation features of a wire transfer. Credit card fraud has proven to be a major expense.

For online bill payment, the customer typically authorizes a debit of their bank account to pay a bill. The authorization may be for one time or periodic payments. Although the customer has some control over when and whether the bill is paid, they cannot choose the electronic funds transfer network that may be most suited to their transaction. Although there are different electronic funds transfer networks available, such as FEDWIRE, ACH, SWIFT or CHIP, the customer is limited to the network provided by the bill payment service. Electronic funds transfer costs may be higher than necessary because the network used by the bill payment service is not appropriate for the size and urgency of a particular transfer.

Current e-commerce systems generate billing information, but rely on outside entities to make the funds transfer. Typically, a credit card is used to effect the payment. Examples of commerce systems that provide online shopping methods but rely on outside payment mechanisms are disclosed in U.S. Pat. No. 5,960,411 to Hartman et al. and U.S. Pat. No. 6,125,352 to Franklin et al.

It would be desirable to have an electronic payment system that would overcome the above disadvantages.

### SUMMARY OF THE INVENTION

One aspect of the present invention provides an electronic payment system allowing payment by a single action over any electronic funds transfer network.

Another aspect of the present invention provides an electronic payment system reducing exposure of credit card and other personal information on the Internet.

Another aspect of the present invention provides an electronic payment system allowing the option to choose any electronic funds transfer network.

The payment method of the present invention facilitates funds payment according to the wishes of a customer, allowing the customer in a single action to instruct an electronic funds transfer network to move funds from an originating bank to a beneficiary bank. The electronic payment method comprises the steps of establishing funds transfer static data containing an identification number corresponding to a customer ID, and funds transfer information; completing a customer transaction to the point of payment; providing the customer ID at a transaction point; in response to a single action, transmitting payment input data containing the customer ID, payment amount, and transaction date; generating funds transfer data by adding funds transfer static data and funds transfer status data to the payment input data; monitoring the status data to decide if payment is due; and generating a funds transfer instruction including the appropriate information data when the status data indicate the payment is due.

The step of establishing funds transfer static data involves obtaining information from the customer about where the payment funds originate, how they are to be transferred, and where they are to go. The customer information for the funds transfer static data can be obtained in a number of ways, depending on the customer preferences. The information can be input by the customer directly at a remote computer, then transmitted to the over the Internet using secure transmission. If the customer is concerned about Internet security, the information can be supplied to a telephone operator, who manually enters the information. If the customer is more comfortable with written transactions, the information can be entered on a paper form, then manually keyed in.

The funds transfer static data contains a unique identification number to identify the particular funds transfer scheme. The identification number is mapped to a customer ID, which is supplied to the customer alphanumerically (represented as a written number) or electronically. The customer ID may last indefinitely or may be limited. For example, the customer ID can be limited to a certain time period, limited to a certain number of uses, or limited to a single use.

The step of completing a customer transaction to the point of payment involves selecting the items to be purchased or the bill to be paid and calculating a final payment amount. The customer can be connected to the Internet on a private computer, connected to the Internet at a public computer away from home, or be shopping at a store. The final payment amount could include the cost of goods and services, shipping, taxes, and any other miscellaneous charges.

The step of providing the customer ID at a transaction point involves the customer supplying the customer ID. If the customer ID is stored electronically on a private computer, it can be recalled from storage and incorporated in the web page automatically without the customer seeing it. If the customer is using a public computer, the customer ID can be entered manually in a web page blank. If the customer is shopping at a store, they can enter the customer ID in a keypad attached to the store's register system. The private or public computer can be wireless, such as a handheld device like a Blackberry™ handheld unit, or wired.

The step of transmitting payment input data containing the customer ID, payment amount, and date in response to a single action involves sending the payment input data from the remote computer or store to a host system for carrying out the payment. Data may be encrypted to provide secure communications. The single action may be hitting a button or providing a voice command: any input to which the remote computer is sensitive. On a private or public computer, the single action can be hitting an HTML payment button on the web page, where the payment button is programmed to send the payment input data across the Internet. The payment button may be embedded in the merchant's web page or as a payment option in an electronic wallet. At a store, the single action can be hitting an acknowledge button on the keypad attached to the store's register system. The step may also include using a hardware or software method to authenticate the customer's identity.

The step of generating funds transfer data involves taking payment input data, adding funds transfer static data for the identification number corresponding to the customer ID, adding funds transfer status data, and storing the result as funds transfer data. The funds transfer status data records the steps of the payment transaction and typically includes an operator ID for the person or agent taking the action, an action date, an action time, and a verification control number for each step in the payment process.

The step of monitoring the funds transfer status data involves checking the funds transfer status data of the funds transfer data to determine when the funds transfer instruction should be generated and sent. During the monitoring step, the system can review existing funds transfer options and select an option based on pre-programmed business rules considering such parameters as speed and expense. The system can then enter the funds transfer data to take advantage of the best option. Also during the monitoring step, the system reviews the identity of the originating bank to determine whether the funds transfer is a scheduled transfer or extraction transfer.

The step of generating a funds transfer instruction involves converting the funds transfer data to a funds transfer instruction and forwarding the instruction to the originating bank when the monitoring step determines it is appropriate. The funds transfer instruction is generated in a data format compatible with the data format of the originating bank. For a scheduled transfer, the instruction is transmitted to the bank a portion at a time, with the banks computer indicating when it is ready to receive the next portion. For an extraction transfer, the instruction is sent to the originating bank in a continuous stream.

Once the originating bank has received the funds transfer instruction, the originating bank executes the funds transfer over the predetermined local or international electronic finds transfer and settlement network, such as FEDWIRE, ACH, SWIFT, or CHIP. The finds are transferred to the beneficiary bank and the transaction is complete.

The system can provide messages to the transaction participants at different stages in the transaction, informing them of status or completion. For example, the customer can be notified when the transfer instruction is sent or when the transfer is complete.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 shows a schematic representation of one embodiment of a system according to the present invention.

FIG. 2 shows a flow chart representing one embodiment of a method of the present invention.

FIG. 3 shows a funds transfer data record of one embodiment of a system according to the present invention.

### DETAILED DESCRIPTION OF THE PRESENTLY PREFERRED EMBODIMENTS

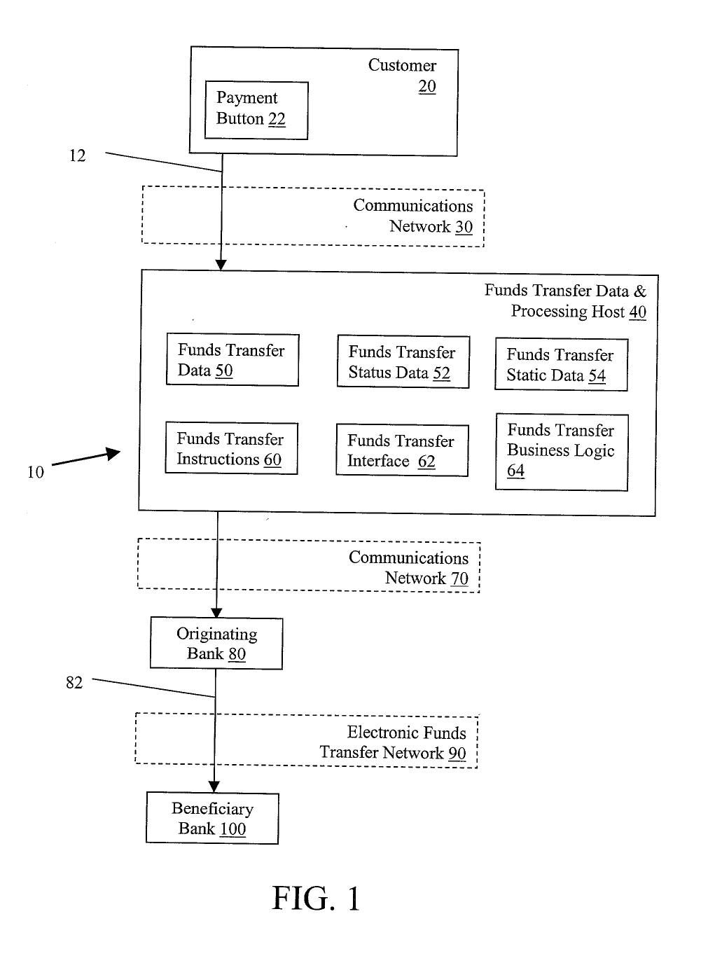

FIG. 1 is a schematic representation of one embodiment of a electronic payment system according to the present invention. A system 10 for payment comprises a customer 20 remotely forwarding payment input data 12 over a communications network 30 to a funds transfer data and processing host 40. Customer 20 may be a person using a private or public computer, or a person in a retail shop. Communications network 30 is any communications network suitable for data transfer: a public access network like the Internet and the World Wide Web, a private dial-up network, a corporate intranet, or other similar networks. Data may be encrypted to provide secure communications. The communications network 30 can be wireless or wired, or a combination of the two.

Customer 20 selects items to purchase or bills to pay and completes the transaction to the point where payment is required. Customer 20 then sends funds transfer data and processing host 40 payment input data 12 through the single action of pushing payment button 22. Payment button 22 is typically an HTML button embedded in the web page the customer is viewing, such as a merchant's e-commerce page or a bill payment service page. The payment button 22 may also appear as a payment option within an electronic wallet and could also have other associated functions, such as forwarding shipping information. If the customer 20 is using a private, secure computer, the payment button 22 may contain or use embedded code already stored on the computer, such that the customer 20 does not need to enter identifying information. If the customer 20 is using a public, unsecured computer, customer 20 may need to enter identifying information before pushing payment button 22. Various hardware or software methods can be used to authenticate the customer's identity, if desired.

In an alternate embodiment, the payment button could be provided as a payment source in an electronic wallet. The customer sets up a link to the payment button within the electronic wallet, so that the payment button will appear as one of the payment sources in the electronic wallet while shopping or paying bills on-line. The customer shops on-line, selecting items for purchase and the payment button as the associated payment source. The payment button would be activated by the link when the customer checks out.

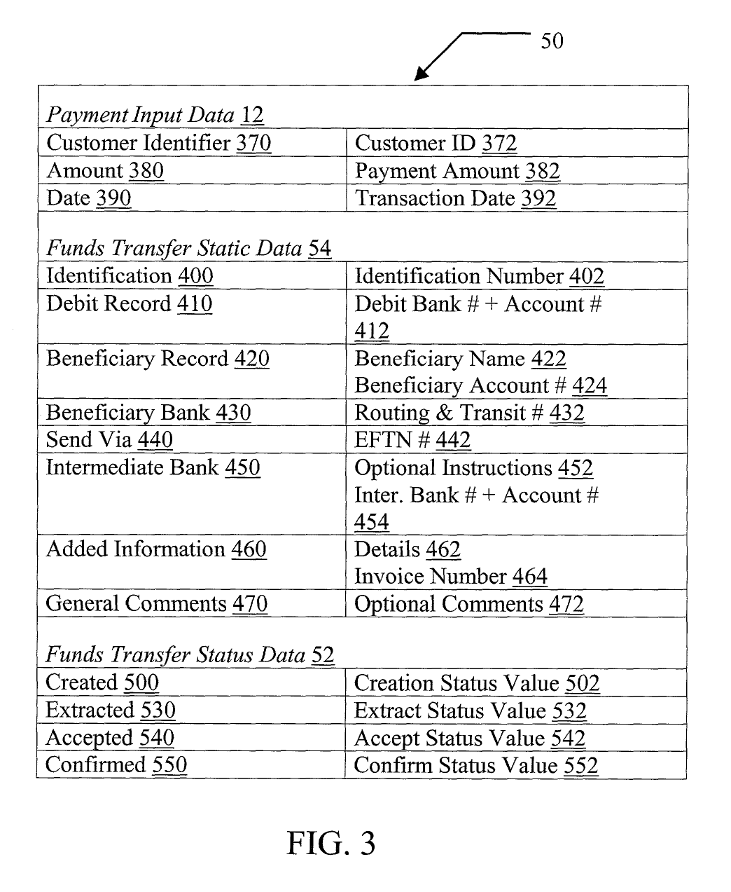

When pushed, payment button 22 sends payment input data 12 to the funds transfer data and processing host 40. Payment input data 12 includes information about the payment, such as customer ID, payment amount, and transaction date (FIG. 3). The customer ID corresponds to the identification number stored in funds transfer static data 54.

Funds transfer data and processing host 40 generates finds transfer data 50, by appending funds transfer static data 54 and funds transfer status data 52 to payment input data 12, after verifying that the customer ID is current and valid and corresponds to a valid identification number. Funds transfer static data 54 includes specific funds transfer information, such as identification, debit record, beneficiary record, beneficiary bank, send via, intermediate bank, added information, and general comments (FIG. 3). In an alternative embodiment, the funds transfer static data 54 can include credit card information, such as customer name, credit card number, and expiration date, so that the funds transfer can be carried out as a charge against the customer's credit card, rather than a bank funds transfer. The funds transfer static data 54 is entered and stored in the funds transfer and processing host 40 before customer 20 uses the electronic payment system. The funds transfer static data 54 can be entered by customer 20 over an electronic communications network, entered by an operator taking the information from customer 20, or entered by an operator from a paper form filled out by customer 20.

Funds transfer status data 52 includes information about the status of the funds transfer, such as whether the transfer has been created, extracted, accepted, or confirmed (FIG. 3). The status values are updated as the funds transfer proceeds, e.g., the created data is updated when customer 20 pushes the payment button 22 and the confirmed data is updated when execution is complete. Each status value typically includes an operator ID for the person or agent taking the action, an action date, an action time, and a control number for verifying the action.

Funds transfer data and processing host 40 then monitors funds transfer data 50 to determine when the conditions for executing the funds transfer are met. When conditions are met, funds transfer data and processing host 40 extracts funds transfer instruction 60 from funds transfer data 50 by applying funds transfer interface 62. Funds transfer interface 62 contains an arrangement of rules and formats for making a transfer from any given bank over any electronic funds transfer network, arranged in control tables. Funds transfer data and processing host 40 selects the control table for the particular bank and electronic funds transfer network in a given transaction and uses them to extract funds transfer instruction 60. The appropriate funds transfer protocol is selected based on the desired funds transfer network as well as the originating bank involved. The control table drives the program to prepare the transfer instructions and forward them to originating bank for execution by their legacy system. Funds transfer data and processing host 40 may also apply funds transfer business logic 64 to determine the least cost or most expeditious method to execute the funds transfer. Funds transfer business logic 64 includes decision support to help determine the best transfer method and consider alternatives.

Funds transfer data and processing host 40 then sends funds transfer instruction 60 to originating bank 80 over communications network 70, using a prompt-response, record level, or file transfer communication protocol. Communications network 70 is any communications network suitable for data transfer: a public access network like the Internet and the World Wide Web, a private dial-up network, a corporate intranet, or other similar networks. Funds transfer instruction 60 is compatible with the legacy computer systems of originating bank 80.

Originating bank 80 transfers funds 82 to beneficiary bank 100 over electronic funds transfer network 90. Electronic funds transfer network 90 is any local or international network capable of electronically moving funds between banks, such as FEDWIRE, ACH, SWIFT, or CHIP.

Various advisory messages can be provided during the process to inform the participants that the transfer is proceeding smoothly or has encountered problems. For example, the electronic funds transfer network 90 can advise the beneficiary bank 100 and originating bank 80 when the funds transfer is complete. The advisory message can be provided at any point a party to the transaction finds it desirable to confirm an action has occurred.

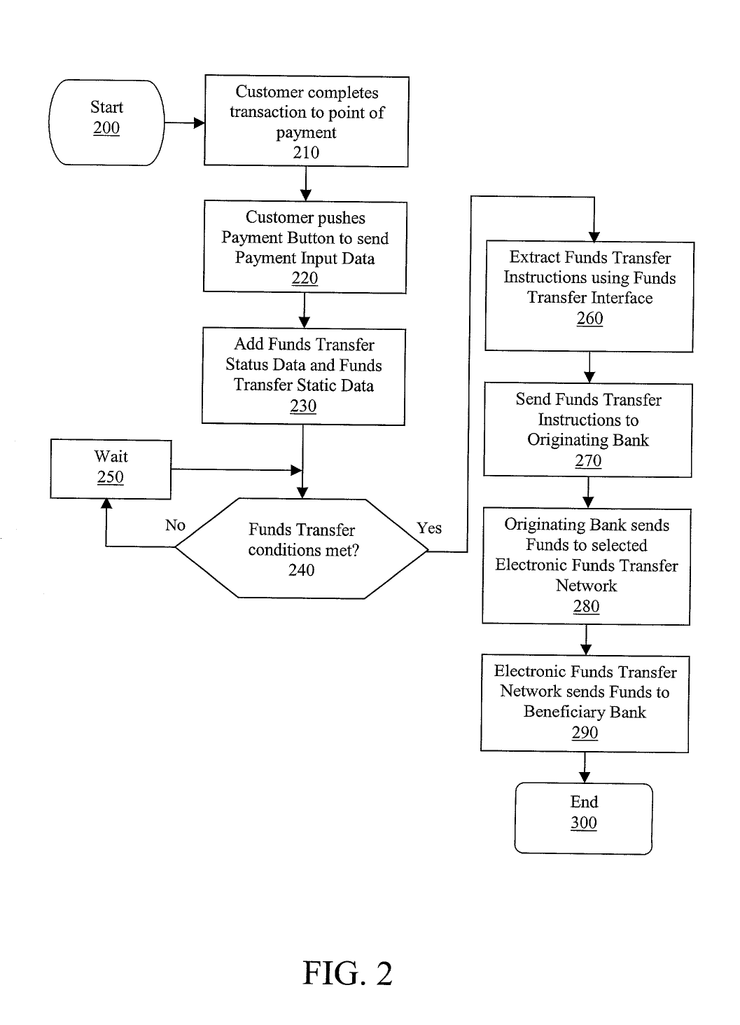

FIG. 2 is a flow charts representing one embodiment of an electronic payment system of the present invention. The customer has previously provided the funds transfer static data stored in the funds transfer data and processing host and has obtained a customer ID. The funds transfer static data contains information about the desired funds transfer, such as identification, debit record, credit record, intermediate bank, added information, and general comments.

The customer shops or decides what bills to pay, so that there is a total amount due for a particular transaction (step 210). The customer may be at a private computer, in which case a payment button is present on the display embedded in the merchant's web page, or at a public computer, in which case a payment button and a customer ID blank are present on the display. At the public computer, the customer enters their customer ID in the customer ID blank. The private or public computer can be wireless, such as a handheld device like a Blackberry™ handheld unit, or wired. In a single action, the customer pushes the payment button to send the payment input data containing the customer ID, payment amount, and transaction date to the funds transfer data and processing host (step 220). The payment input data may also contain customer authentication information.

Various software or hardware methods can be used to authenticate the customer's identity, if desired. The authentication can be an external token as simple as a password, like a personal identification number (PIN), assigned to the customer and input by the customer. The next level of sophistication would be a password good for a limited number of transactions or for a limited time. A variation on the password system is to use a continuously changing password coordinated between the customer and the funds transfer data and processing host, such as provided by the SecureID system sold by Security Dynamics. Various hardware devices permanently or temporarily provided at the computer could be used for authentication. An encoded card, an access disk, or a computer port mounted device might be required to supply a software key before allowing a transaction to go forward. Biometric devices, such as retinal scanners or fingerprint detectors, could be used to verify an individual customer's identity. The method selected depends on the degree of certainty required.

The funds transfer data and processing host adds funds transfer static data and funds transfer status data to the payment input data to form funds transfer data (step 230), matching the customer ID with a unique identification number in the funds transfer static data. The funds transfer static data contains the previously entered data about how the funds transfer is to be carried out and the funds transfer status data tracks the progress of the funds transfer. The funds transfer data and processing host also verifies that the customer ID in the payment input data corresponds to a valid identification number in the funds transfer static data.

The funds transfer data and processing host then monitors conditions to see if the transfer should be executed (step 240). The conditions monitored may be any external conditions, such as time or currency exchange rates. If conditions are not met, the funds transfer data and processing host waits and checks again later (step 250). Once conditions are met, the funds transfer data and processing host processes the funds transfer.

The funds transfer data and processing host extracts funds transfer instructions from the funds transfer data by applying a funds transfer interface (step 260). The funds transfer interface contains the rules and formats for various banks and electronic funds transfer networks in the form of control tables, and provides the rules and formats needed to make a transfer from a specified originating bank over a specified electronic funds transfer network. The funds transfer instructions are sent to the originating bank (step 270), which sends funds to the selected electronic funds transfer network (step 280), which in turn forwards them to the beneficiary bank (step 290). This concludes the funds transfer (step 300).

FIG. 3 shows a funds transfer data record of one embodiment of a electronic payment system according to the present invention. Funds transfer data 50 comprises payment input data 12, funds transfer static data 54, and funds transfer status data 52. As shown in FIG. 1, funds transfer data 50 is created by the funds transfer data and processing host 40 combining payment input data 12 with funds transfer static data 54 and funds transfer status data 52.

Payment input data 12 of FIG. 3 contains the information from a specific payment transaction, and further comprises fields for customer 370, amount 380, and date 390. Each field may contain associated data: customer ID 372, payment amount 382, and transaction date 392. The associated data contains the specific information from a specific payment transaction. The customer ID 372 identifies the customer making the payment and corresponds to an identification number 402 in the funds transfer static data 54. The payment amount 382 identifies the transaction amount and the amount of funds to be transferred. The transaction date 392 identifies the transaction date.

Funds transfer static data 54 contains information provided by the customer to direct the funds transfer and is stored in the funds transfer data and processing host before the electronic payment system can be used. The funds transfer static data 54 further comprises fields for identification 400, debit record 410, beneficiary record 420, beneficiary bank 430, send via 440, intermediate bank 450, added information 460, and general comments 470. Each field may contain associated data: an identification number 402 with the identification 400; a debit bank #+account # 412 with the debit record 410; a beneficiary name 422 and a beneficiary account # 424 with the beneficiary record 420; a routing & transit # 432 with the beneficiary bank 430; an EFTN # 442 with send via 440; an optional instructions 452 and an inter. bank #+account # 454 with the intermediate bank 450; a details 462 and a invoice number 464 with the added information 460; and an optional comments 472 with the general comments 472. As an alternative, funds transfer static data 54 can be set up to provide payment by credit card. The customer would provide their credit card information (customer name, card number, expiration date), rather than the bank transfer information. When the transaction is executed, the electronic payment system will debit the customer's credit card account instead of their bank account.

The associated data contains information for the funds transfer transaction. The identification number 402 identifies the specific funds transfer arrangement. The debit bank #+account # 412 identifies the originating bank account to be debited. The beneficiary name 422 identifies the beneficiary to be credited and the beneficiary account # 424 identifies account to be credited. The routing & transit # 432 identifies the routing path for the transfer. The EFTN # 442 identifies the electronic funds transfer network to be used for the transfer. The optional instructions 452 and bank #+account # 454 provide instructions and account numbers if specific intermediate banks are to be used in the funds transfer. The details 462 and invoice number 464 identify the commercial transaction with which the funds transfer is associated. The optional comments 472 identify any optional information.

Funds transfer status data 52 contains information about the progress of the funds transfer, and further comprises fields for whether the transfer has been created 500, extracted 530, accepted 540, or confirmed 550. Each field may contain associated data regarding the status of the funds transfer, which is updated as the funds transfer proceeds: the creation status value 502 with created 500; the extract status value 532 with extracted 530; the accept status value 542 with accepted 540; and the confirm status value 552 with confirmed 550. Each status value typically includes an operator ID for the person or agent taking the action, an action date, an action time, and a control number for verifying the action.

It should be noted that the above fields and data shown in FIG. 3 are examples of the key fields and that many more are available to meet specific needs.

The above-described electronic payment system is intended to provide an electronic payment system allowing payment by a single action over any electronic funds transfer network, but is clearly suited for other uses. By improving electronic payment, the system makes new payment options available, increasing flexibility and reducing costs. It will be evident that there are additional embodiments which are not illustrated above but which are clearly within the scope and spirit of the present invention. The above description and drawings are therefore intended to be exemplary only.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. An electronic payment system for a customer to direct payment over an electronic funds transfer network from an originating bank, comprising:
means for receiving payment input data;
means for storing funds transfer static data;
means for storing funds transfer status data;
means for generating funds transfer data from the payment input data, the funds transfer static data, and the funds transfer status data; and
means for generating a funds transfer instruction from the funds transfer data, wherein the funds transfer data is appropriate to the originating bank and the electronic funds transfer network.

2. The system of claim 1 wherein the funds transfer instruction generating means is responsive to funds transfer business logic.

3. The system of claim 1 wherein the funds transfer static data comprises bank funds transfer information.

4. The system of claim 1 wherein the funds transfer static data comprises credit card funds transfer information.

5. The system of claim 1 wherein the customer provides the payment input data over the Internet from a personal computer.

6. The system of claim 5 wherein the personal computer sends the payment input data in response to a single action.

7. The system of claim 5 wherein the personal computer provides a payment button to send the payment input data at a single click of the payment button.

8. The system of claim 7 wherein the payment button appears on a merchant Web page.

9. The system of claim 7 wherein the payment button appears in an electronic wallet.

10. The system of claim 7 wherein the payment button provides a blank for the customer to enter a customer ID.

11. The system of claim 1 wherein the customer provides the payment input data over a wireless communications network.

12. The system of claim 1 wherein the customer provides the payment input data over a private communications network.

13. The system of claim 1 wherein the payment input data comprises customer identification, payment amount, and transaction date.

14. The system of claim 13 wherein the payment input data further comprises customer authentication information.

15. The system of claim 1 wherein the electronic finds transfer network is pre-determined.

16. The system of claim 1 wherein the electronic funds transfer network is selected from the group consisting of FEDWIRE, ACH, SWIFT, and CHIP.

17. An electronic payment method for a customer to direct payment over an electronic funds transfer network from an originating bank, comprising the steps of:
establishing finds transfer static data;
completing a transaction to the point of payment;
pushing a payment button to transmit payment input data;
creating funds transfer status data;
adding the finds transfer static data and the finds transfer status data to the payment input data to form funds transfer data;
monitoring the funds transfer data and conditions to see if the transfer should be executed;
waiting if the conditions are not met;
extracting funds transfer instructions from the finds transfer data by applying a funds transfer interface if the conditions are met; and
sending the finds transfer instructions to the originating bank.

18. The method of claim 17, further comprising the step of authenticating the identity of the customer.

19. The method of claim 18 wherein the step of authenticating the identity of the customer further comprises the step of checking a personal identification number.

20. The method of claim 18 wherein the step of authenticating the identity of the customer further comprises the step of checking biometric information.

21. The method of claim 18 wherein the step of authenticating the identity of the customer further comprises the step of checking a software key.

22. A computer readable medium storing a computer program for electronic payment, the computer program comprising:
computer readable code for establishing funds transfer static data;
computer readable code for completing a transaction to the point of payment;
computer readable code for pushing a payment button to transmit payment input data;
computer readable code for creating funds transfer status data;
computer readable code for adding the funds transfer static data and the funds transfer status data to the payment input data to form funds transfer data;
computer readable code for monitoring the funds transfer data and conditions to see if the transfer should be executed;
computer readable code for waiting if the conditions are not met;
computer readable code for extracting funds transfer instructions from the funds transfer data by applying a funds transfer interface if the conditions are met; and
computer readable code for sending the funds transfer instructions to the originating bank.

23. The computer readable medium of claim 22, wherein the computer program further comprises computer readable code for authenticating the identity of the customer.
